(19) United States
(12) Patent Application Publication
(10) Pub. No.: US 2026/0349723 A1
(43) Pub. Date: Nov. 5, 2026

(54) METHOD AND APPARATUS WITH VECTOR OPERATION INSTRUCTION PROCESSING

(71) Applicants: Samsung Electronics Co., Ltd., Suwon-si (KR); Xi'an Jiaotong University, Xi'an (CN)

(72) Inventors: Lei RAO, Xi’an (CN); Gang SUN, Xi’an (CN); Kuizhi MEI, Xi’an (CN)

(73) Assignees: Samsung Electronics Co., Ltd., Suwon-si (KR); Xi'an Jiaotong University, Xi'an (CN)

(21) Appl. No.: 19/461,004

(22) Filed: Jan. 27, 2026

(30) Foreign Application Priority Data
Mar. 21, 2025 (CN) 202510341572.4
Sep. 25, 2025 (KR) 10-2025-0139072

(51) Int. Cl. G06F 9/30

(52) U.S. Cl. CPC G06F 9/30036; G06F 9/30098

(57) ABSTRACT

A processor-implemented method includes storing, in a configuration information cache register, vector configuration information corresponding to each of vector operation instructions within vector loop code of a loop structure, marking the configuration information cache register storing the vector configuration information, using an offset at a starting position within the vector operation instruction corresponding to the vector configuration information to the vector loop code of the loop structure, counting the offset at the starting position within the vector operation instruction within the vector loop code to the vector loop code of the loop structure, and performing, in response to execution of the vector loop code, a vector operation using the vector configuration information in the configuration information cache register marked with the offset, in response to reaching a vector operation instruction in which a count matches the offset.

### CROSS-REFERENCE TO RELATED APPLICATIONS

This application claims the benefit under 35 USC § 119(a) of Chinese Patent Application No. 202510341572.4, filed on Mar. 21, 2025 in the China National Intellectual Property Administration, and Korean Patent Application No. 10-2025-0139072, filed on Sep. 25, 2025 in the Korean Intellectual Property Office, the entire disclosures of which are incorporated herein by reference for all purposes.

### BACKGROUND

### 1. Field

The following description relates to a method and apparatus with vector operation instruction processing.

### 2. Description of Related Art

A reduced instruction set computer-five (RISC-V) instruction set architecture (ISA) may be applied to modern computing devices, such as warehouse-scale cloud computers, high-performance mobile devices, small embedded systems, and the like.

In a loop structure of the RISC-V ISA, the number of address processing instructions in a loop may increase as the number of loops increases, and a corresponding address may be repeatedly called by a vector read instruction in a process of loop execution.

In addition, when operations are performed between various data types in a loop, data type conversion instructions may be frequently executed, and the corresponding operation may take up a considerable portion of execution counts during the execution of a program processing a large amount of data.

Furthermore, on a data path, a vector operation instruction may only be executed after vector configuration is complete and configuration information is set, thus causing a pipeline bubble.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one or more general aspects, a processor-implemented method includes storing, in a configuration information cache register, vector configuration information corresponding to each of vector operation instructions within vector loop code of a loop structure, marking the configuration information cache register storing the vector configuration information, using an offset at a starting position within the vector operation instruction corresponding to the vector configuration information to the vector loop code of the loop structure, counting the offset at the starting position within the vector operation instruction within the vector loop code to the vector loop code of the loop structure, and performing, in response to execution of the vector loop code, a vector operation using the vector configuration information in the configuration information cache register marked with the offset, in response to reaching a vector operation instruction in which a count matches the offset.

The vector operation instruction in the vector loop code of the loop structure may have a second set number, the configuration information cache register may have a first set number, and the first set number may be greater than or equal to the second set number.

The configuration information cache register may be set in unused encoding of a reduced instruction set computer-five (RISC-V) instruction set architecture (ISA).

The method further may include, in response to a current round loop of the vector loop code being completed, resetting the count to 0 and determining whether to execute the vector loop code again.

The method further may include determining whether the current round loop is completed, according to a jump instruction that is set based on one or more bits among a funct2 part of a reduced instruction set computer-five (RISC-V) instruction set architecture (ISA).

The storing, in the configuration information cache register, of the vector configuration information corresponding to each of the vector operation instructions within the vector loop code of the loop structure may include setting the configuration information cache register based on one or more bits among a funct2 part of a reduced instruction set computer-five (RISC-V) instruction set architecture (ISA).

The method further may include storing the vector configuration information and the marked configuration information cache register according to a configuration information setting instruction and an offset tag instruction which are set based on one or more bits among a funct2 part of a reduced instruction set computer-five (RISC-V) instruction set architecture (ISA).

The performing of the vector operation using the vector configuration information in the configuration information cache register marked with the offset may include reading a vector for the vector operation instruction to perform an operation according to a vector read instruction that is set based on one or more bits among a funct2 part of a reduced instruction set computer-five (RISC-V) instruction set architecture (ISA).

The performing of the vector operation using the vector configuration information in the configuration information cache register marked with the offset may include performing, in response to a presence of a 2ⁿ multiplication operation within the vector loop code, a direct shift operation by setting a shifter.

The performing of the vector operation using the vector configuration information in the configuration information cache register marked with the offset may include merging a zeroing command and a restore and command within the loop structure into a single command.

In one or more general aspects, a non-transitory computer-readable storage medium may store instructions that, when executed by one or more processors, configured the one or more processors to perform any one, any combination, or all of operations and/or methods described herein.

In one or more general aspects, an electronic device includes one or more processors comprising processing circuitry, and memory comprising one or more storage media storing instructions that, when executed individually or collectively by the one or more processors, cause the electronic device to store, in a configuration information cache register, vector configuration information corresponding to each of vector operation instructions within vector loop code of a loop structure, mark the configuration information cache register storing the vector configuration information, using an offset at a starting position within the vector operation instruction corresponding to the vector configuration information to the vector loop code of the loop structure, [symbol]
count the offset at the starting position within the vector operation instruction within the vector loop code to the vector loop code of the loop structure, and perform, in response to execution of the vector loop code, a vector operation using the vector configuration information in the configuration information cache register marked with the offset, in response to reaching a vector operation instruction in which a count matches the offset.

The vector operation instruction in the vector loop code of the loop structure may have a second set number, the configuration information cache register may have a first set number, and the first set number may be greater than or equal to the second set number.

The configuration information cache register may be set in unused encoding of a reduced instruction set computer-five (RISC-V) instruction set architecture (ISA).

The execution of the instructions further may cause the electronic device to, in response to a current round loop of the vector loop code being completed, reset the count to 0 and determine whether to execute the vector loop code again.

The execution of the instructions further may cause the electronic device to determine whether the current round loop is completed, according to a jump instruction that is set based on one or more bits among a funct2 part of a reduced instruction set computer-five (RISC-V) instruction set architecture (ISA).

The execution of the instructions further may cause the electronic device to set the configuration information cache register based on one or more bits among a funct2 part of a reduced instruction set computer-five (RISC-V) instruction set architecture (ISA).

The execution of the instructions further may cause the electronic device to store the vector configuration information and the marked configuration information cache register according to a configuration information setting instruction and an offset tag instruction which are set based on one or more bits among a funct2 part of a reduced instruction set computer-five (RISC-V) instruction set architecture (ISA).

The execution of the instructions further may cause the electronic device to read a vector for the vector operation instruction to perform an operation according to a vector read instruction that is set based on one or more bits among a funct2 part of a reduced instruction set computer-five (RISC-V) instruction set architecture (ISA).

In one or more general aspects, a processor-implemented method includes marking a configuration information cache register storing vector configuration information corresponding to each of vector operation instructions within vector loop code of a loop structure, using an offset at a starting position within the vector operation instruction corresponding to the vector configuration information to the vector loop code of the loop structure, and performing, in response to execution of the vector loop code, a vector operation using the vector configuration information in the configuration information cache register marked with the offset, in response to reaching a vector operation instruction in which a count matches the offset.

Other features and aspects will be apparent from the following detailed description, the drawings, and the claims.

### BRIEF DESCRIPTION OF THE DRAWINGS

With regard to the description of the drawings, the same or similar reference numerals may be used to refer to the same or similar components.

FIG. 1 illustrates a flowchart of an example of a method of processing a vector operation instruction based on a reduced instruction set computer-five (RISC-V) instruction set architecture (ISA) according to one or more embodiments.

FIG. 2 illustrates an example of a method of processing a vector operation instruction based on a RISC-V ISA according to one or more embodiments.

FIG. 3 illustrates an example of an encoding format of a configuration information setting instruction and an offset marking instruction according to one or more embodiments.

FIG. 4 illustrates an example of an encoding format of a vector read instruction according to one or more embodiments.

FIG. 5 illustrates an example of an encoding format of a jump instruction according to one or more embodiments.

FIG. 6 illustrates an example of an electronic device that processes a vector operation instruction based on a RISC-V ISA according to one or more embodiments.

Throughout the drawings and the detailed description, unless otherwise described or provided, the same drawing reference numerals may be understood to refer to the same elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences within and/or of operations described herein are merely examples, and are not limited to those set forth herein, but may be changed as will be apparent after an understanding of the disclosure of this application, except for sequences within and/or of operations necessarily occurring in a certain order. As another example, the sequences of and/or within operations may be performed in parallel, except for at least a portion of sequences of and/or within operations necessarily occurring in an order, e.g., a certain order. Also, descriptions of features that are known after an understanding of the disclosure of this application may be omitted for increased clarity and conciseness.

The terminology used herein is for describing various examples only and is not to be used to limit the disclosure. The articles “a,” “an,” and “the” are intended to include the plural forms as well, unless the context clearly indicates otherwise. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof, or the alternate presence of an alternative stated features, numbers, operations, members, elements, and/or combinations thereof. Additionally, while one embodiment may set forth such terms “comprise” or “comprises,” “include” or “includes,” and “have” or “has” specify the presence of stated features, numbers, operations, members, elements, and/or combinations thereof, other embodiments may exist where one or more of the stated features, numbers, operations, members, elements, and/or combinations thereof are not present.

Unless otherwise defined, all terms including technical or scientific terms used herein have the same meaning as those commonly understood by one of ordinary skill in the art to which disclosure pertains and specifically in the context on an understanding of this disclosure. Terms, such as those defined in commonly used dictionaries, are to be interpreted as having a meaning that is consistent with their meaning in the context of the relevant art and specifically in the context of the present disclosure, and are not to be interpreted in an idealized or overly formal sense unless expressly so defined herein.

When describing the examples with reference to the accompanying drawings, like reference numerals refer to like components and a repeated description related thereto is omitted. In the description of examples, detailed description of well-known related structures or functions is omitted when it is deemed that such description may cause ambiguous interpretation of the present disclosure.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Throughout the specification, when a component or element is described as being “on”, “connected to,” “coupled to,” or “joined to” another component, element, or layer it may be directly (e.g., in contact with the other component, element, or layer) “on”, “connected to,” “coupled to,” or “joined to” the other component, element, or layer or there may reasonably be one or more other components, elements, layers intervening therebetween. When a component, element, or layer is described as being “directly on”, “directly connected to,” “directly coupled to,” or “directly joined” to another component, element, or layer there can be no other components, elements, or layers intervening therebetween. Likewise, expressions, for example, “between” and “immediately between” and “adjacent to” and “immediately adjacent to” may also be construed as described in the foregoing.

As used herein, the term “and/or” includes any one and any combination of any two or more of the associated listed items. The phrases “at least one of A, B, and C”, “at least one of A, B, or C”, and the like are intended to have disjunctive meanings, and these phrases “at least one of A, B, and C”, “at least one of A, B, or C” (e.g., each phrase may include any one of the respective items alone, all of the items listed together, and all possible combinations thereof), and the like also include examples where there may be one or more of each of A, B, and/or C (e.g., any combination of one or more of each of A, B, and C), unless the corresponding description and embodiment necessitates such listings (e.g., “at least one of A, B, and C”) to be interpreted to have a conjunctive meaning.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application. The use of the term “may” herein with respect to an example or embodiment (e.g., as to what an example or embodiment may include or implement) means that at least one example or embodiment exists where such a feature is included or implemented, while all examples are not limited thereto. The use of the terms “example”, “embodiment”, and “example embodiment” herein have a same meaning (e.g., the phrasing ‘in an or one example’ has a same meaning as ‘in an or one embodiment“ and ‘in an or one example embodiment’), and “one or more examples” has a same meaning as “one or more embodiments” and “one or more example embodiments”. Still further, each of multiple or all separately described an/one “example”, “embodiment”, “example embodiment”, as well as “examples”, “embodiments”, “example embodiments”, herein may be included, in combination, in a same embodiment in any combination.

The same name may be used to describe components having a common function in different examples. Unless otherwise mentioned, the description of one example may be applicable to another example. Thus, duplicated description is omitted for conciseness.

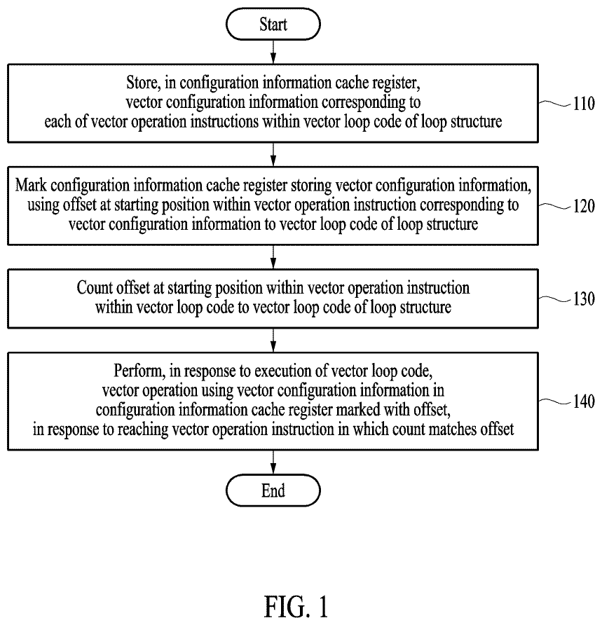

Hereinafter, examples of a method and apparatus for processing a vector operation instruction based on a reduced instruction set computer-five (RISC-V) instruction set architecture (ISA) are described in detail with reference to FIGS. 1 to 6.

FIG. 1 illustrates a flowchart of an example of a method of processing a vector operation instruction based on a RISC-V ISA according to one or more embodiments. Although one or more of operations of FIG. 1 are illustrated as being performed sequentially, one or more of the operations may be performed in a different order, one or more of the operations may be omitted, two or more of the operations may be performed in parallel or simultaneously, and/or other operations may be additionally performed without departing from the spirit and scope of the described embodiments.

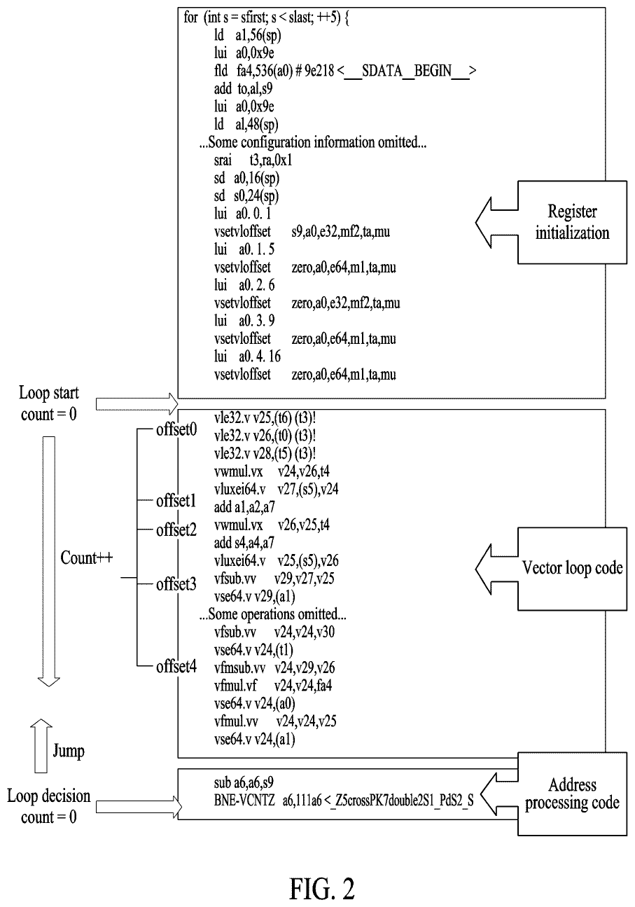

FIG. 2 illustrates an example of a method of processing a vector operation instruction based on the RISC-V ISA according to one or more embodiments.

FIG. 1 will be described with reference to FIG. 2. Vector loop code among the pieces of code illustrated in FIG. 2 may correspond to the vector loop code of the loop structure described in the present disclosure, and the vector loop code may include a vector operation instruction that may be repeatedly executed depending on a loop judgment.

Referring to FIG. 1, Referring to FIG. 1, in operation 110, a method of processing a vector operation instruction based on a RISC-V ISA (hereinafter, the processing method) may store, in a configuration information cache register, vector configuration information corresponding to each of vector operation instructions within vector loop code of a loop structure.

In operation 120, the processing method may mark the configuration information cache register storing the vector configuration information, using an offset at a starting position within the vector operation instruction corresponding to the vector configuration information to the vector loop code of the loop structure.

Here, the vector operation instruction in the vector loop code of the loop structure may have a second set number, the configuration information cache register may have a first set number, and the first set number may not be less than (e.g., may be greater than or equal to) the second set number. For example, the first set number of the configuration information cache register may not be less than the second set number of the vector operation instruction. Here, the first set number and the second set number may be set according to an experiment or by a user.

For example, when the number of types of vector operation instructions in the vector loop code is greater than the first set number, the second set number of vector operation instructions, which does not exceed (e.g., is less than or equal to) the first set number, may be selected and configured. The vector configuration information may include, but is not limited to, vector length, data type, and mask information.

The configuration information cache register may be set to an unused encoding of the RISC-V ISA.

The configuration information cache register may be set using an encoding not used in the RISC-V standard. For example, the first set number of the configuration information cache register may be set based on at least one bit (e.g., 28th and 29th bits) among a funct 2 part of the RISC-V ISA. However, examples are not limited thereto. This is only an example, and examples are not limited thereto. The at least one bit may be an unused bit in the funct2 part of the RISC-V ISA.

By taking out (e.g., removing) a vector configuration instruction within the vector loop code of the loop structure and placing it in a register initialization part, such as the register initialization part of FIG. 2, the vector configuration information may be stored in the configuration information cache register according to an order of vector operation instructions before a loop starts. The corresponding tasks (e.g., operations 110 and 120) may serve as the register initialization part for storing vector configuration information corresponding to the second set number (for example, but not limited to, 5) of vector configuration instructions (e.g., a vsetvli instruction) of the loop, and may mark a corresponding configuration information cache register with a relative offset address at a starting position within a vector operation instruction corresponding to each vector configuration information to the vector loop code of the loop structure.

In one or more embodiments, for the tasks (e.g., operations 110 and 120), a new configuration mode may be controlled by adding new encodings to instructions such as vector configuration instructions (e.g., vsetvli) and vector read data instructions (e.g., vle) at the RISC-V vector instruction execution pipeline level.

The processing method may store the vector configuration information according to a configuration information setting instruction set based on at least one bit (for example, but not limited to, 30th and 31st bits) of the funct 2 part of the RISC-V ISA, and may mark the configuration information cache register according to an offset marking instruction set based on at least one bit (for example, but not limited to, the 30th and 31st bits) of the funct 2 part of the RISC-V ISA. This is an example and not a limitation, and the at least one bit may be an unused bit in the funct2 part of the RISC-V ISA. For example, a new offset marking instruction vsetoffset and a configuration information setting instruction vsetcsr, which are compatible with the retrieved vector (RVV) 1.0 of the RISC-V ISA, may be added. The newly added offset marking instruction may be used for marking the configuration information cache register by storing the offset in the configuration information cache register before the vector loop code of the loop structure. The newly added configuration information setting instruction may be used for storing the vector configuration information, such as a vector length (vl) and a data type (vtype), in the configuration information cache register before the vector loop code of the loop structure is executed.

The processing method may store the vector configuration information and the marked configuration information cache register, according to a configuration information setting instruction and an offset tag instruction which are set based on at least one bit among the funct2 part of the RISC-V ISA.

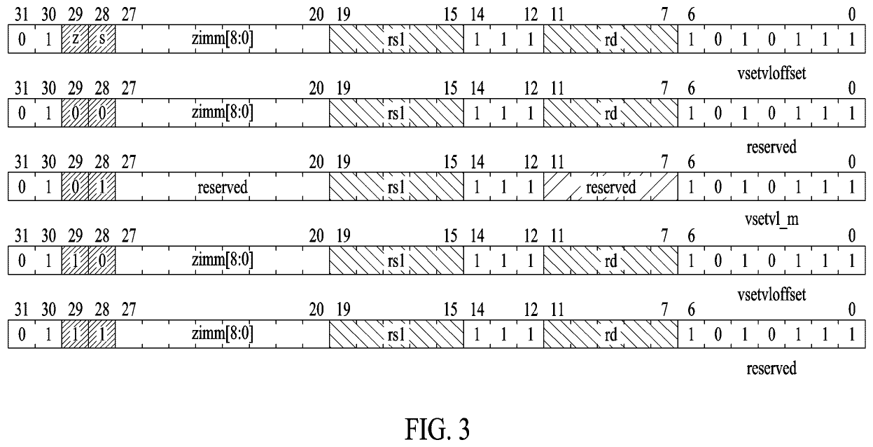

FIG. 3 illustrates an example of an encoding format of a configuration information setting instruction and an offset marking instruction according to one or more embodiments.

Referring to FIG. 3, the processing method may be used to define an offset marking instruction vsetoffset and a configuration information setting instruction vsetcsr when the 30th and 31st bits are 10. The 29th bit may be set to vzreo (z of FIG. 3) to initialize a count to 0 in operation 130 of FIG. 1. The 28th bit may be set to shift (s of FIG. 3) to set a binary multiplication operation of vfmsub in the vector loop code of the loop structure.

In addition, the processing method may read a vector that a vector operation instruction needs for an operation, according to a vector read instruction (e.g., vle!) set based on at least one bit (for example, but not limited to, the 28th bit) of the funct2 part of the RISC-V ISA. For example, the at least one bit may be an unused bit in a funct2 part of the RISC-V ISA but is not limited thereto.

This is only an example of the description of FIG. 3, and the present disclosure is not limited thereto.

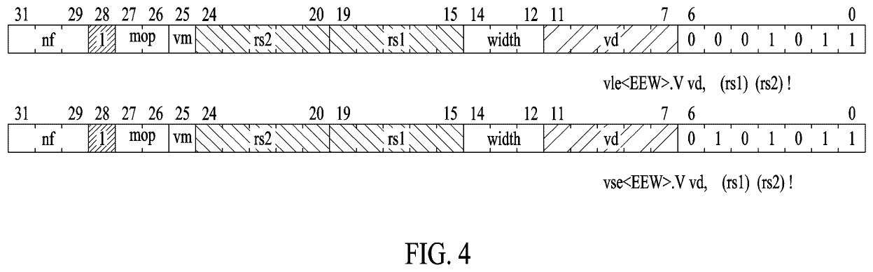

FIG. 4 illustrates an example of an encoding format of a vector read instruction according to one or more embodiments.

Referring to FIG. 4, an instruction structure of the vector read command vle! may be as follows:
vle<EEW>.Vvd′(rs1) (rs2)!

Here, EEW may represent a valid element width within the vector, V may represent a vector, vd may represent a value of the vector, and rs1 and rs2, which are optional, may each represent a storage address (e.g., a register) of the vector.

The instruction structure of the vector read instruction vle! may be encoded according to an encoding format illustrated in FIG. 4, and nf, mop, vm, and width of FIG. 4, which are predetermined bits of the RISC-V ISA, may all be used to represent a function.

By implementing an address pointer of the operation that is configured to automatically index a vector address used in a subsequent loop (e.g., repeated execution of the vector loop code) when a loop terminates, the method and apparatus of one or more embodiments may reduce an execution time occupied by an address pointer processing instruction (or the address processing code of FIG. 2) in a great number of loop operations.

In operation 130, the processing method may count the offset at the starting position within the vector operation instruction within the vector loop code to the vector loop code of the loop structure. Counting may be performed by setting a counter.

In operation 140, the processing method may, in response to execution of the vector loop code, perform a vector operation, directly using the vector configuration information in the configuration information cache register marked with the offset, in response to reaching a vector operation instruction in which a count matches the offset. Here, a count value of the counter may correspond to a relative offset address. For example, a count value offset0 may correspond to a relative offset address 0 (the starting position to the vector loop code of the loop structure may be 0), and a count value offset 1 may correspond to a relative offset address 1 (the starting position to the vector loop code of the loop structure may be 1). However, the present disclosure is not limited thereto.

As illustrated in FIG. 2, in response to execution of the vector loop code, the counter may be initialized and counting may begin according to execution of the vector operation instruction in the loop. When reaching an instruction in which a count matches the marked relative offset address, by performing the vector operation using a vector operation instruction corresponding to the vector configuration information, directly using configuration information of the configuration information cache register marked with the relative offset address to which the count value of the counter corresponds, the method and apparatus of one or more embodiments may perform the vector operation without having to perform a vector configuration instruction separately before execution, thereby reducing and/or eliminating a pipeline bubble. For example, within the vector loop code, the method and apparatus of one or more embodiments may use the configuration information of the corresponding configuration information cache register only when the vector operation instruction is one of the second set number of types.

In addition, in response to the current round loop of the vector loop code being completed, the count may be reset to 0 and whether to execute the vector loop code again may be determined. For example, it may be determined whether a current round loop is completed, according to a jump instruction that is set based on at least one bit (for example, but not limited to, 12th to 14th bits) among a funct 2 part of the RISC-V ISA. For example, the at least one bit may be an unused bit in a funct2 part of the RISC-V ISA but is not limited thereto. The counter may be zeroed after the loop is completed by setting jump instructions BEQ-VCNTZ and BNE_VCNTZ, which are compatible with RVV 1.0 of the RISC-V ISA.

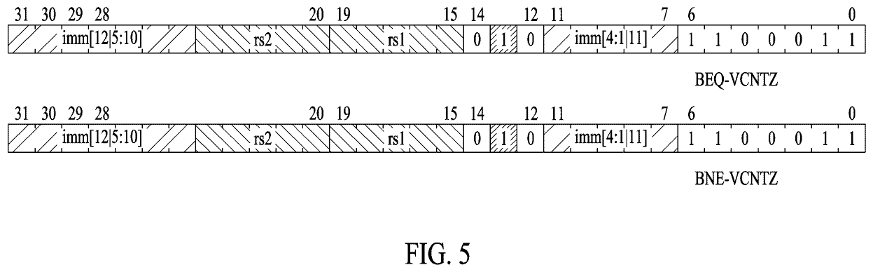

FIG. 5 illustrates an example of an encoding format of a jump instruction according to one or more embodiments.

Referring to FIG. 5, the instruction structure may be as follows:

BEQ-VCNTZ rs1 x0 offset[1:12]

BNE-VCNTZ rs1 x0 offset[1:12]

Here, rs1 may represent a register, x0 may represent a counter value, and offset[1:12] may represent an offset value.

Instruction structures of the jump instructions BEQ-VCNTZ and BNE_VCNTZ may be encoded according to the encoding format illustrated in FIG. 5.

Optionally, in response to a presence of a 2ⁿ multiplication operation within vector loop code, the operation may be simplified by performing a direct shift operation by setting a shifter. The operation above may be performed by setting the following instructions:
li rs1, (imm), #Load shift number and store it in register rs1
vsetvl_m rs1 #vsetvl_m rs1 shift setting, rs1 is used to store the shift number
vfmsubm.vvvd, vs1, vs2, vm #vd[i]=(vs1[i]*vd[i]−vs2[i])*2^{rs1}
vfmaddm.vvvd, vs1,vs2,vm #vd[i]=(vs1[i]*vd[i]+vs2[i])*2^{rs1}

Here, li may represent loading the shift number into the register rs1, vfmsubm.vv may represent a multiply-subtract operation, vfmaddm.vv may represent a multiply-add operation, vd may represent a vector value, vs1·vs2 may represent vector values at different positions, and vm may be used to express a function.

Optionally, a zeroing command (e.g., vmv.sx) and a restore and command (e.g., vfredusum.vs) within a loop structure may be merged into a single command. For example, vfredusumz.vd may be defined, and a vs2 instruction may merge the zeroing command and the restore and command into a single command (e.g., vfredusumz.v).

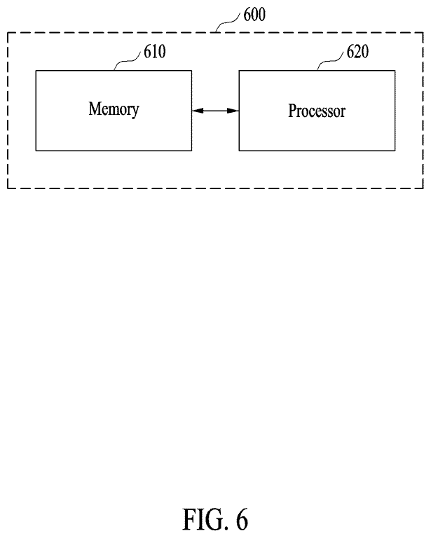

FIG. 6 illustrates an example of an electronic device that processes a vector operation instruction based on a RISC-V ISA according to one or more embodiments.

Referring to FIG. 6, an electronic device 600 may include a memory 610 (e.g., one or more memories) and a processor 620 (e.g., one or more processors).

The memory 610 may store application programs, storage data, and an operating system (OS) for controlling the overall operation of the electronic device 600. The memory 610 may store various instructions that may be executed by the processor 620. For example, the memory 610 may be or include a non-transitory computer-readable storage medium storing instructions that, when executed by the processor 620, configured the processor 620 to perform any one, any combination, or all of the operations and/or methods described herein with reference to FIGS. 1-6.

The processor 620 may perform the operations of the electronic device 600 of FIG. 6.

The instructions may, when individually or collectively executed by the processor 620, cause the electronic device 600 to store, in a configuration information cache register, vector configuration information corresponding to each of vector operation instructions within vector loop code of a loop structure, mark the configuration information cache register storing the vector configuration information, using an offset at a starting position within the vector operation instruction corresponding to the vector configuration information to the vector loop code of the loop structure, count the offset at the starting position in the vector operation instruction within the vector loop code to the vector loop code of the loop structure, and perform, in response to execution of the vector loop code, a vector operation using the vector configuration information in the configuration information cache register marked with the offset, in response to reaching a vector operation instruction in which a count matches the offset. Here, the vector operation instruction in the vector loop code of the loop structure may have a second set number, the configuration information cache register may have a first set number, and the first set number may not be less than the second set number.

The configuration information cache register may be set to an unused encoding of the RISC-V ISA.

The instructions, when executed individually or collectively by the processor 620, may cause the electronic device 600 to, in response to a current round loop of the vector loop code being completed, reset the count to 0 and determine whether to execute the vector loop code again.

The instructions, when executed individually or collectively by the processor 620, may cause the electronic device 600 to determine whether the current round loop is completed, according to a jump instruction that is set based on at least one bit among a funct2 part of the RISC-V ISA.

The processor 620 may also execute computer-executable instructions to perform a task of setting a first predetermined number of configuration information cache registers based on at least one bit of the funct2 part of the RISC-V ISA.

The instructions, when individually or collectively executed by the processor 620, may cause the electronic device 600 to store the vector configuration information and the marked configuration information cache register according to a configuration information setting instruction and an offset tag instruction which are set based on at least one bit among a funct2 part of the RISC-V ISA.

The processor 620 may also execute computer-executable instructions to perform a task of reading a vector required for a vector operation instruction to perform an operation according to a vector read instruction that is set based on at least one bit of the funct2 part of the RISC-V ISA.

The processor 620 may also execute computer-executable instructions to perform a task of performing a direct shift operation by setting a shifter, in response to a presence of a 2ⁿ multiplication operation within the vector loop code.

The processor 620 may also execute computer-executable instructions to perform a task of merging a zeroing command and a restore and command within the loop structure into a single command.

The electronic devices, memories, processors, electronic device 600, memory 610, and processor 620 described herein, including descriptions with respect to respect to FIGS. 1-6, are implemented by or representative of hardware components. As described above, or in addition to the descriptions above, examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit (ALU), a digital signal processor (DSP), a microcomputer, a programmable logic controller, a field-programmable gate array (FPGA), a programmable logic array (PLU), a microprocessor, or any other device or combination of devices that is configured to respond to and execute instructions (e.g., code or coding) in a defined manner to achieve a desired result. In one example, a processor or computer includes, or is connected to, one or more memories storing the instructions or software that are executed by the processor or computer. Hardware components implemented by a processor or computer may execute the instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both, and thus while some references may be made to a singular processor or computer, such references also are intended to refer to multiple processors or computers. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. As described above, or in addition to the descriptions above, example hardware components may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing. Thus, references to a processor herein mean processing circuitry (e.g., circuitry that includes one or more processing element(s) circuits). One or more processors comprising processing circuitry also refers to each processor comprising processing circuitry, as well as some or all of the one or more processors comprising the same processing circuitry. In addition, processors(s) and controller(s), as a non-limiting example, do not mean human processing or human control, but rather, refer to hardware components as described herein, as non-limiting examples.

The methods illustrated in, and discussed with respect to, FIGS. 1-6 that perform the operations described in this application are performed by computing hardware, for example, by one or more processors or computers, implemented as described above implementing the instructions (e.g., computer or processor/processing device readable instructions) or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations. References to a processor, or one or more processors, as a non-limiting example, configured to perform two or more operations refers to a processor or two or more processors being configured to collectively perform all of the two or more operations, as well as a configuration with the two or more processors respectively performing any corresponding one of the two or more operations (e.g., with a respective one or more processors being configured to perform each of the two or more operations, or any respective combination of one or more processors being configured to perform any respective combination of the two or more operations). Likewise, a reference to a processor-implemented method is a reference to a method that is performed by one or more processors or other processing or computing hardware of a device or system.

The instructions or software to control computing hardware, for example, one or more processors or computers, to implement the hardware components and perform the methods as described above may be written as computer programs, code segments, or other executable instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media, and thus, not a signal per se. Thus, references herein to storage media mean storage media hardware, and does not mean transitory media, nor a signal per se. As described above, or in addition to the descriptions above, examples of a non-transitory computer-readable storage medium include one or more of any of read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROMs, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and/or any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above and all drawing disclosures, the scope of the disclosure is also inclusive of the claims and their equivalents, i.e., all variations within the scope of the claims and their equivalents are to be construed as being included in the disclosure.

What is claimed is:

1. A processor-implemented method comprising:
storing, in a configuration information cache register, vector configuration information corresponding to each of vector operation instructions within vector loop code of a loop structure;
marking the configuration information cache register storing the vector configuration information, using an offset at a starting position within the vector operation instruction corresponding to the vector configuration information to the vector loop code of the loop structure;
counting the offset at the starting position within the vector operation instruction within the vector loop code to the vector loop code of the loop structure; and
performing, in response to execution of the vector loop code, a vector operation using the vector configuration information in the configuration information cache register marked with the offset, in response to reaching a vector operation instruction in which a count matches the offset.

2. The method of claim 1, wherein
the vector operation instruction in the vector loop code of the loop structure has a second set number,
the configuration information cache register has a first set number, and
the first set number is greater than or equal to the second set number.

3. The method of claim 1, wherein the configuration information cache register is set in unused encoding of a reduced instruction set computer-five (RISC-V) instruction set architecture (ISA).

4. The method of claim 1, further comprising, in response to a current round loop of the vector loop code being completed, resetting the count to 0 and determining whether to execute the vector loop code again.

5. The method of claim 4, further comprising determining whether the current round loop is completed, according to a jump instruction that is set based on one or more bits among a funct2 part of a reduced instruction set computer-five (RISC-V) instruction set architecture (ISA).

6. The method of claim 1, wherein the storing, in the configuration information cache register, of the vector configuration information corresponding to each of the vector operation instructions within the vector loop code of the loop structure comprises setting the configuration information cache register based on one or more bits among a funct2 part of a reduced instruction set computer-five (RISC-V) instruction set architecture (ISA).

7. The method of claim 1, further comprising storing the vector configuration information and the marked configuration information cache register according to a configuration information setting instruction and an offset tag instruction which are set based on one or more bits among a funct2 part of a reduced instruction set computer-five (RISC-V) instruction set architecture (ISA).

8. The method of claim 1, wherein the performing of the vector operation using the vector configuration information in the configuration information cache register marked with the offset comprises reading a vector for the vector operation instruction to perform an operation according to a vector read instruction that is set based on one or more bits among a funct2 part of a reduced instruction set computer-five (RISC-V) instruction set architecture (ISA).

9. The method of claim 1, wherein the performing of the vector operation using the vector configuration information in the configuration information cache register marked with the offset comprises performing, in response to a presence of a 2ⁿ multiplication operation within the vector loop code, a direct shift operation by setting a shifter.

10. The method of claim 1, wherein the performing of the vector operation using the vector configuration information in the configuration information cache register marked with the offset comprises merging a zeroing command and a restore and command within the loop structure into a single command.

11. A non-transitory computer-readable storage medium storing instructions that, when executed by one or more processors, configure the one or more processors to perform the method of claim 1.

12. An electronic device comprising:
one or more processors comprising processing circuitry; and
memory comprising one or more storage media storing instructions that, when executed individually or collectively by the one or more processors, cause the electronic device to:
store, in a configuration information cache register, vector configuration information corresponding to each of vector operation instructions within vector loop code of a loop structure;
mark the configuration information cache register storing the vector configuration information, using an offset at a starting position within the vector operation instruction corresponding to the vector configuration information to the vector loop code of the loop structure;
count the offset at the starting position within the vector operation instruction within the vector loop code to the vector loop code of the loop structure; and
perform, in response to execution of the vector loop code, a vector operation using the vector configuration information in the configuration information cache register marked with the offset, in response to reaching a vector operation instruction in which a count matches the offset.

13. The electronic device of claim 12, wherein
the vector operation instruction in the vector loop code of the loop structure has a second set number,
the configuration information cache register has a first set number, and
the first set number is greater than or equal to the second set number.

14. The electronic device of claim 12, wherein the configuration information cache register is set in unused encoding of a reduced instruction set computer-five (RISC-V) instruction set architecture (ISA).

15. The electronic device of claim 12, wherein the execution of the instructions further causes the electronic device to, in response to a current round loop of the vector loop code being completed, reset the count to 0 and determine whether to execute the vector loop code again.

16. The electronic device of claim 15, wherein the execution of the instructions further causes the electronic device to determine whether the current round loop is completed, according to a jump instruction that is set based on one or more bits among a funct2 part of a reduced instruction set computer-five (RISC-V) instruction set architecture (ISA).

17. The electronic device of claim 12, wherein the execution of the instructions further causes the electronic device to set the configuration information cache register based on one or more bits among a funct2 part of a reduced instruction set computer-five (RISC-V) instruction set architecture (ISA).

18. The electronic device of claim 12, wherein the execution of the instructions further causes the electronic device to store the vector configuration information and the marked configuration information cache register according to a configuration information setting instruction and an offset tag instruction which are set based on one or more bits among a funct2 part of a reduced instruction set computer-five (RISC-V) instruction set architecture (ISA).

19. The electronic device of claim 12, wherein the execution of the instructions further causes the electronic device to read a vector for the vector operation instruction to perform an operation according to a vector read instruction that is set based on one or more bits among a funct2 part of a reduced instruction set computer-five (RISC-V) instruction set architecture (ISA).

20. A processor-implemented method comprising:
marking a configuration information cache register storing vector configuration information corresponding to each of vector operation instructions within vector loop code of a loop structure, using an offset at a starting position within the vector operation instruction corresponding to the vector configuration information to the vector loop code of the loop structure; and
performing, in response to execution of the vector loop code, a vector operation using the vector configuration information in the configuration information cache register marked with the offset, in response to reaching a vector operation instruction in which a count matches the offset.
